(19) United States
(12) Patent Application Publication
(10) Pub. No.: US 2026/0011228 A1
(43) Pub. Date: Jan. 8, 2026

(54) method for vehicle-theft driver's identification with privacy protection

(71) Applicant: Hangzhou Normal University, Hangzhou (CN)

(72) Inventors: Xiumei Li, Hangzhou (CN); Shucheng Ying, Hangzhou (CN); Qingyun Xie, Hangzhou (CN); Qi Xie, Hangzhou (CN)

(21) Appl. No.: 18/796,339

(22) Filed: Aug. 7, 2024

(30) Foreign Application Priority Data
Jul. 8, 2024 (CN) 2024109026439

(51) Int. Cl. G08B 13/196; G06Q 50/26; G06V 10/82; G06V 20/59; G06V 40/16

(52) U.S. Cl. CPC G08B 13/19647; G06Q 50/265; G06V 10/82; G06V 20/59; G06V 40/168; G06V 40/172

(57) ABSTRACT

This invention pertains to the field of vehicle anti-theft technology and discloses a vehicle anti-theft method based on encrypted facial recognition. The method includes: periodically capturing facial data of the driver within the vehicle, using an in-vehicle neural network-based facial feature extraction model to extract feature vectors, and comparing these vectors with a preset whitelist to confirm authorization. If the driver is an unauthorized person, the feature vector is transmitted to the internet of vehicles for detection, where abnormal recognition triggers an alarm and uploads the data to a trusted authority within the internet of vehicles for tracking. The internet of vehicles consists of a trusted authority, auxiliary servers, cloud servers, roadside units, and vehicles, all of which deploy physically unclonable functions. This system enables rapid identity verification and anomaly detection to ensure driving safety. It can resist side-channel attacks on physical devices, capture attacks, and collusion attacks on servers, thereby protecting equipment safety and data privacy.

### FIELD OF TECHNOLOGY

This invention belongs to the field of vehicle anti-theft technology, specifically involving a method based on encrypted facial recognition.

### BACKGROUND TECHNOLOGY

In modern society, automobiles have become indispensable means of transportation in people's daily lives. However, frequent vehicle theft incidents not only cause financial losses to vehicle owners but also seriously impact public safety. According to statistics, millions of vehicles are stolen globally each year, posing significant threats to people's property security and social stability. Therefore, the development of an efficient and secure vehicle theft recognition solution is urgently needed.

Current vehicle anti-theft systems mainly rely on mechanical locks and electronic anti-theft devices. However, these methods have many drawbacks: mechanical locks are susceptible to violent break-ins, and electronic anti-theft devices may be vulnerable to signal interference or hacking. Thus, traditional anti-theft measures can hardly provide adequate security assurance.

### Content of Invention

The purpose of the proposed invention is to provide a vehicle anti-theft method based on encrypted facial recognition to address the existing technological issues.

To achieve the aforementioned objectives, the proposed invention provides a vehicle anti-theft method based on encrypted facial recognition. The method includes:

Periodically obtaining facial data of the current driver in the vehicle.

Inputting the facial data into a facial feature extraction model for feature extraction, resulting in the facial feature vector corresponding to the current driver. The facial feature extraction model is integrated into the vehicle's control system and is constructed based on neural networks.

Comparing the extracted facial feature vector with feature vectors recorded in a predefined whitelist to determine if the facial feature vector is authorized. If authorized, authentication is granted. If unauthorized, transmitting the facial feature vector data to the internet of vehicles for recognition, obtaining recognition results. Generating alarm information and uploading it to the trusted authority of the internet of vehicles for tracking and location processing when the recognition result is abnormal.

The internet of vehicles includes a trusted authority and auxiliary servers, cloud servers, roadside units, and vehicles registered within this trusted authority. The trusted authority is a legitimate system responsible for managing and controlling national citizen identity information. Physical unclonable functions are deployed in both the auxiliary servers, cloud servers, roadside units, and vehicles.

Optionally, the method compares the detected facial feature vector with the feature vectors recorded in a predefined whitelist, specifically:

Calculating the Euclidean distance between the detected facial feature vector and the feature vectors recorded in the whitelist based on the Euclidean distance formula.

Based on the computed Euclidean distance value, determining whether the detected facial feature vector is authorized information.

Optionally, the process of registering the auxiliary server with the trusted authority specifically includes:

The auxiliary server sends a registration request to the trusted authority. Upon receiving the request, the trusted authority generates corresponding homomorphic encryption key pairs and standard encryption key pairs for the auxiliary server. These keys are then sent to the auxiliary server. The auxiliary server computes the response values for the homomorphic encryption key pairs and the standard encryption keys using a physical unclonable function. Based on these response values, the auxiliary server calculates protection parameters for its keys and stores and backs up these calculated parameters, completing the registration process.

Optionally, the process of registering the cloud server with the trusted authority specifically includes:

The cloud server sends a registration request to the trusted authority. Upon receiving the request, the trusted authority generates standard encryption key pairs for the cloud server and sends them to the cloud server. The cloud server protects and stores these standard encryption key pairs using a physical unclonable function.

Subsequently, the cloud server selects citizen identity information based on the designated region and encrypts this information using the homomorphic encryption key pairs corresponding to the auxiliary server. The encrypted citizen identity information is then transferred to the cloud server for storage and backup, completing the registration process.

Optionally, the process of registering the roadside unit with the trusted authority specifically includes:

The roadside unit sends a registration request to the trusted authority. Upon receiving the registration request, the trusted authority generates registration data for the roadside unit, which includes unique identity data and the roadside unit's private key. This data is securely transmitted to the roadside unit through a secure channel.

Upon receiving the registration data, the roadside unit performs availability verification. Once verified, the roadside unit protects and stores the registration data and secret parameters using a physical unclonable function, thereby completing the registration process.

Optionally, the process of registering the vehicle with the trusted authority specifically includes:

The vehicle sends its chassis number data to the trusted authority for registration. Upon receiving this data, the trusted authority generates registration parameters. The vehicle validates these registration parameters. Upon successful validation, the vehicle generates encryption keys and constructs a whitelist based on citizen identity information. Subsequently, the vehicle stores and backs up the generated encryption keys and whitelist, thereby completing the registration process.

Optionally, transmitting the detected facial feature vector data to the internet of vehicles for detection and recognition specifically includes:

Implementing mutual authentication and key negotiation between the vehicle and the roadside unit to obtain a session key. Encrypting the detected facial feature vector data using the homomorphic encryption key pair corresponding to the auxiliary server. Encrypting the homomorphic ciphertext data of the facial feature vector based on the session key. Transmitting the encrypted homomorphic ciphertext data to the cloud server. The cloud server computes and compares the encrypted homomorphic ciphertext data using homomorphic encryption technology and garbled circuit techniques to obtain the recognition result.

The technical effects of the proposed invention are as follows:

The invention continuously monitors the driver's face in driving vehicles to determine if the vehicle is stolen, triggering identity recognition algorithms once a potential theft is detected.

The invention employs mutual authentication to verify the identities of vehicles and Road Side Units (RSUs) and negotiate session keys. Through mutual authentication, common attacks such as man-in-the-middle and replay attacks are effectively prevented, while session key establishment ensures secure communication between vehicles and RSUs.

The On-Board Unit (OBU) in vehicles, Road Side Unit (RSU), cloud server, and auxiliary server in this invention deploy Physical Unclonable Function (PUF), which withstands physical device side-channel attacks, capture attacks, and collusion attacks on servers, ensuring device security and data privacy.

By utilizing collaborative efforts between cloud servers and auxiliary servers, this invention employs homomorphic encryption and garbled circuit techniques to effectively safeguard the privacy and security of driver facial data and facial databases.

### FIGURE LEGENDS

To clearly illustrate the embodiments of the proposed invention or the technical solutions in the prior art, brief descriptions of the accompanying drawings used in the embodiments are provided below. It is evident that the figures described below are merely some embodiments of the proposed invention, and those skilled in the art can derive other figures based on these figures without exercising inventive effort.

The accompanying figures, which form part of this application, are provided to further understand the present application. Exemplary embodiments and their descriptions are used to explain the present application and do not constitute inappropriate limitations of the present application. In the figures:

FIG. 1 depicts the framework structure of the vehicle network system in embodiments of the proposed invention.

FIG. 2 shows the logic circuit diagram in embodiments of the proposed invention.

FIG. 3 presents the implementation flowchart in embodiments of the proposed invention.

### SPECIFIC IMPLEMENTATION

Detailed descriptions of various exemplary embodiments of the proposed invention are provided below. This detailed description should not be construed as limiting the invention but rather as providing a more detailed explanation of certain aspects, features, and implementation schemes of the invention.

The terms used in the proposed invention are intended specifically to describe particular embodiments and should not be construed as limiting the invention. Additionally, numerical ranges disclosed herein should be understood to specifically disclose every intermediate value between the upper and lower limits of the range. Any smaller ranges within stated values or within intermediate values between such ranges are also encompassed within the invention. The upper and lower limits of these smaller ranges may independently be included or excluded from the range.

Unless otherwise stated, all technical and scientific terms used herein have the same meaning as understood by those skilled in the art of the invention. While the invention has been described with reference to preferred methods, any similar or equivalent methods may be used in the implementation or testing of the invention as described herein. All references mentioned in this specification are incorporated by reference to disclose and describe methods related to the referenced literature. In case of conflict with any incorporated literature, the content of this specification shall prevail.

Numerous modifications and variations of specific embodiments of the proposed invention described in this specification are possible without departing from the scope or spirit of the invention, as would be apparent to those skilled in the art. Other embodiments derived from the disclosure of this invention would be apparent to those skilled in the art. This application specification and its embodiments are exemplary only.

Regarding terms such as “comprising,” “including,” “having,” “containing,” etc., used herein, these are open-ended terms meaning “including but not limited to.”

It should be noted that, unless conflicting, features of embodiments in the present application may be combined with each other. The following detailed description will refer to the accompanying drawings and combine with the embodiments to illustrate the present application.

### EMBODIMENT 1

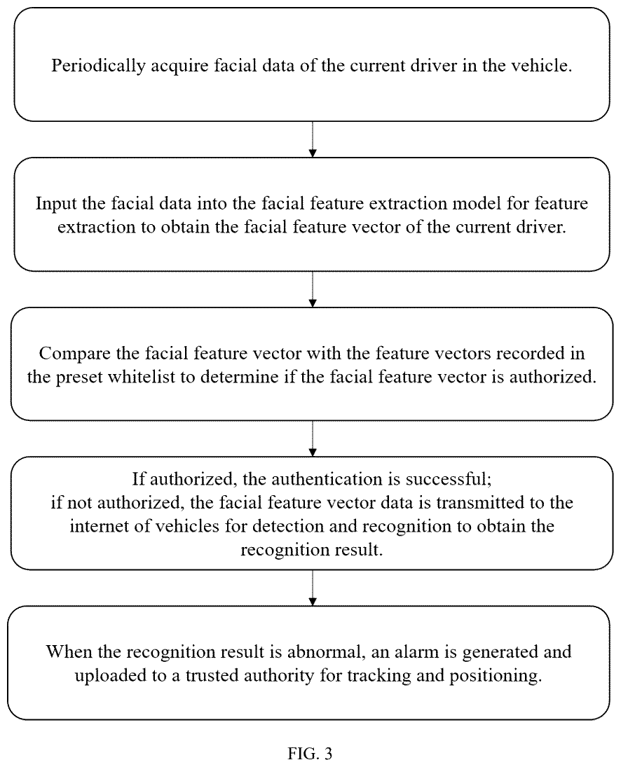

As shown in FIGS. 1 to 3, this embodiment provides a vehicle anti-theft method based on encrypted facial recognition. The method includes:

Periodically obtaining facial data of the current driver in the vehicle;

Inputting the facial data into a facial feature extraction model for feature extraction to obtain the detected facial feature vector of the current driver. The facial feature extraction model is integrated into the vehicle's control system and is constructed based on neural networks.

Comparing the detected facial feature vector with feature vectors recorded in a preset whitelist to determine if the detected facial feature vector is authorized. If authorized, authentication is granted; if unauthorized, transmitting the detected facial feature vector data to the internet of vehicles for detection and recognition. Upon detecting an abnormal recognition result, generating alarm information and uploading it to the trusted authority center within the internet of vehicles for tracking and localization processing.

The internet of vehicles includes a trusted authority center and auxiliary servers, cloud servers, roadside units, and vehicles registered within the trusted authority center.

The trusted authority center operates as a legally authorized system managing national citizen identity information. Physical Unclonable Functions (PUFs) are deployed in the auxiliary servers, cloud servers, roadside units, and vehicles to enhance device security and protect data privacy.

This embodiment continuously detects the driver's face while the vehicle is moving to determine if the vehicle is stolen. Upon suspicion of theft, it activates an algorithm to identify the driver's identity.

Mutual authentication is employed to verify the identity between vehicles and Roadside Units (RSUs) and negotiate session keys. Mutual authentication effectively prevents common attacks such as man-in-the-middle and replay attacks, while the establishment of session keys ensures secure communication between vehicles and RSUs.

In this embodiment, On-Board Units (OBUs) in vehicles, RSUs at roadside locations, cloud servers, and auxiliary servers deploy Physical Unclonable Functions (PUFs) to resist physical device side-channel attacks, capture attacks, and collusion attacks on servers, thereby safeguarding device security and data privacy.

After mutual authentication and establishment of a secure session key between the suspected stolen vehicle and RSU, the driver's face information and vehicle identity are encrypted using the session key and sent to the RSU. The RSU decrypts this information, encrypts the suspected driver's facial information using the homomorphic public key of the auxiliary validation server, then encrypts the homomorphic ciphertext of the suspected driver's facial information and vehicle information with its own private key before sending it to the cloud server. Upon verifying that the information originates from the RSU, the cloud server collaborates with the auxiliary server to identify the suspected driver's identity. If the local thief's identity is confirmed, the information is sent to the police for further action. If the thief is not local, their information is forwarded to the police station to search for the thief in the national facial database.

This embodiment presents a theft identification scheme based on homomorphic encryption, garbled circuits, mutual authentication, and key negotiation, ensuring high security and privacy protection capabilities. OBUs in vehicles, RSUs at roadside locations, cloud servers, and auxiliary servers deploy Physical Unclonable Functions (PUFs) to resist physical device side-channel attacks, capture attacks, and collusion attacks on servers.

### Specific Steps Include:

Step 1: System initialization;
Step 2: Registration stage;
Step 3: Driver identification stage;
Step 4: Vehicle and RSU authentication and message transmission;
Step 5: Vehicle thief identification stage;

Step 1 and 2 of the registration process involve a series of initialization and registration operations that enable the system to acquire the necessary parameters, keys, and authentication identification information required for task execution. This includes trusted authority such as the police department (PS) selecting and generating necessary elliptic curve parameters, base points, private keys, and public keys, which are then distributed to relevant devices and servers. Additionally, the system deploys symmetric encryption algorithms, secure one-way hash functions, and establishes and maintains a national database of citizen facial feature vectors, ensuring that each registration node, including vehicles, RSUs, and cloud servers, can correctly receive, store, and use these critical security parameters and authentication information, thereby providing a solid foundation for subsequent legal driver identification, vehicle and RSU authentication and message transmission, and vehicle-theft driver identification.

In step 4, the vehicle and RSU authentication and message transmission phase, a series of security protocols and encryption operations ensure secure communication between the vehicle and the roadside unit (RSU). In this stage, the vehicle first generates a random number and a challenge value, and uses a physical unclonable function (PUF) and a hash function to calculate relevant response values and keys. The vehicle and RSU perform mutual authentication to verify each other's identity and exchange necessary encrypted parameters and messages. After receiving information from the vehicle, the RSU will also perform corresponding calculations and verification to ensure the integrity and authenticity of the message. This stage not only ensures the security of the vehicle against side-channel attacks and the RSU against capture attacks, the integrity and confidentiality of data during transmission, but also provides a reliable foundation for subsequent data exchange and collaboration.

In step 5, during the vehicle-theft driver identification stage, precise facial ciphertext recognition of facial feature vectors is achieved by combining anti-server capture attack and anti-conspiracy attack homomorphic encryption and garbled circuit technology. In this phase, the vehicle encrypts the collected driver's facial feature vector and transmits it to the cloud server. The cloud server utilizes fully homomorphic encryption to perform calculations on the ciphertext, ensuring that data remains encrypted throughout processing. Through homomorphic operations, the cloud server can conduct preliminary face matching without decryption, such as calculating Euclidean distances. Subsequently, further secure computations on the facial feature vector are performed using garbled circuit technology to prevent any leakage of sensitive information throughout the entire process. Ultimately, based on the recognition result and in conjunction with location information provided by RSU, the system determines identity details of potential vehicle thieves and enables real-time tracking and positioning of these individuals.

In the system registration phase, auxiliary servers, cloud servers, RSUs, and vehicles undergo registration processes.

During auxiliary server registration, homomorphic encryption key pairs and standard encryption key pairs are initially generated. The homomorphic encryption key pair is used for encrypting facial feature vectors to ensure data privacy and security during processing, with the private key protected using physical unclonable functions (PUF) to guarantee its security and uniqueness.

Similarly, cloud server registration involves generating standard encryption key pairs protected by PUF, along with creating an encrypted facial feature vector database. This database consists of facial feature vectors of selected representative individuals from the region, encrypted using the auxiliary server's homomorphic public key for subsequent facial recognition processes.

RSU and vehicle registrations include generating standard encryption key pairs also protected by PUF, ensuring the security and non-replicability of keys. Identity verification during registration utilizes Schnorr signatures, confirming the legitimacy of devices through signature generation and verification processes with authorities like the police station.

Following the registration phase, vehicles and RSUs undergo mutual authentication and message transmission when a driver's facial features do not match the preset whitelist during detection. This process involves initiating mutual authentication protocols between vehicles and RSUs to ensure mutual authenticity through secure interactions, including random number exchanges and response value calculations. The resulting symmetric key from this authentication ensures subsequent encrypted message transmissions between vehicles and RSUs, maintaining data confidentiality and integrity.

During the thief identification phase, homomorphic encryption and garbled circuit techniques are employed to perform accurate facial recognition without compromising the privacy of facial feature vectors. Scanned facial feature data is encrypted and transmitted to cloud servers for processing, where homomorphic encryption allows computations and comparisons on encrypted facial feature vectors without decryption. This method ensures privacy and security during data transmission and processing, including calculating Euclidean distances between feature vectors to match scanned faces with registered ones in the database. Garbled circuit technology further enhances security by processing and filtering comparison results, generating alerts and reporting anomalies to the police station if scanned facial features do not match any registered legitimate driver features. The police station can then use the provided information for further investigation and tracking to address potential vehicle theft activities promptly.

The specific implementation process of this embodiment includes:

### Step 1: Generate Necessary Parameters

The police station (PS), as a trusted authority, first selects an elliptic curve E(GF_{q}) with base point P, and then chooses its private key skₛ, ∈

$${Z}_{q}^{*} ,$$

computing the public key PKₛ=skₛ·P. Next, a secure symmetric encryption/decryption algorithm Eₛₖ(·)/Dₛₖ(·) and a secure one-way hash function h(·) are selected.

Deploy National Facial Database: The police station (PS) deploys a national database of citizen faces

$$< \vec{{v}_{1}} , {ID}_{i} , {DID}_{i} {>}_{i = 1}^{A N} ,$$

where \vec{v}₁ represents facial feature vectors IDᵢ denotes unique vehicle chassis numbers (default as ⊥), DIDᵢ stands for citizen identity card numbers, and AN denotes the number of pairs of feature vectors in the database.

Through these steps, the police station ensures the foundational security and data integrity of the system, laying a solid groundwork for subsequent vehicle-theft driver's identification and authentication. The encryption and hashing technologies employed during initialization effectively prevent data leaks and tampering, ensuring that only authorized entities can access and manipulate sensitive information. The establishment of the facial database provides essential data support for rapid and accurate identity recognition.

### Step 2: Registration Phase.

The registration phase involves registering various entities into the system.

Auxiliary Server Registration (SA₁): after system initialization, the police station (PS) registers each auxiliary server (SA₁) to ensure its secure and effective operation within the system. The registration process is as follows:

Select Homomorphic Encryption Keys: PS first selects the CKKS homomorphic encryption private key s̅k̅_̅{̅S̅A̅I̅}̅ for auxiliary server SA₁. Using this private key, compute the corresponding public key P̅K̅_̅{̅S̅A̅I̅}̅=S̅K̅_̅{̅S̅A̅I̅}̅·P.

Select Standard Encryption Keys: PS continues by selecting a new private key SK_{SAI} for SA_{I} and calculates the corresponding public key PK_{SAI}=SK_{SAI}·P. Transmit Key Information: Transmit the key information

{S̅K̅_̅{̅S̅A̅I̅}̅, p̅k̅_̅{̅S̅A̅I̅}̅, SK_{SAI}, PK_{SAI}} via a secure channel to auxiliary server SA₁. This step ensures the confidentiality and integrity of data during transmission, preventing theft or tampering of key information.

Generate Challenge and Response Values: Upon receiving the public-private key pair from PS, SA₁ selects a random challenge value C_{SAI} and computes its response value R_{SAI}=PUF₁(C_{SAI}) using a physically unclonable function.

Protect Keys with PUF: SA_{I} then computes ssk_{SAI}=SK_{SAI} ⊕h(R_{SAI}) and S̅S̅K̅_̅{̅S̅A̅I̅}̅=S̅K̅_̅{̅S̅A̅I̅}̅⊕h(R_{SAI}∥1) to protect sk_{SAI} and s̅k̅_̅{̅S̅A̅I̅}̅, respectively, using a hash function h(·) to enhance key security.

Store Key Information: SA_{I} stores the computed information, including {PK_{SAI}, SSK_{SAI}, C_{SAI}, PUF₁, S̅S̅K̅_̅{̅S̅A̅I̅}̅, P̅K̅_̅{̅S̅A̅I̅}̅}, ensuring quick access for encryption and decryption operations when needed.

PS Saves Key Backup: Simultaneously, PS retains a backup of the key information {S̅K̅_̅{̅S̅A̅I̅}̅, P̅K̅_̅{̅S̅A̅I̅}̅, SK_{SAI}, PK_{SAI}} for verification and data recovery purposes.

Through these steps, auxiliary server SA₁ securely registers into the system, equipped with the necessary key information to perform its tasks. This registration process utilizes key generation and PUF technology to ensure key security, preventing unauthorized access and operations. Additionally, the challenge-response mechanism using PUF enhances data integrity and confidentiality during transmission and storage.

Cloud Server Registration (CS_{I}): After system initialization and auxiliary server registration, the police station (PS) proceeds to register each cloud server (CS_{I}) to ensure its secure and efficient operation within the system. The registration process is as follows:

Select Identity and Keys: PS first selects the identity identifier CID₁ and private key sk_{CSI} for cloud server CS₁, calculating the corresponding public key PK_{CSI}=sk_{CSI}·P.

Transmit Key Information: Transmit the key pair {sk_{CSI}, PK_{CSI}} via a secure channel to cloud server CS₁. This step ensures the confidentiality and integrity of data during transmission, preventing theft or tampering of key information.

Generate Challenge and Response Values: Upon receiving the public-private key pair from PS, CS_{I} selects a random challenge value C_{CSI} and computes its response value R_{CSI}=PUF₂(C_{CSI}) using a physically unclonable function (PUF).

Protect Keys with PUF: CSI then computes ssk_{CSI}=sk_{CSI}⊕h(R_{CSI}), using a hash function h(·) to enhance key security.

Select Driver Face Sample Library: PS selects the driver face Sample library

$$< \vec{{v}_{1}} , {ID}_{i} {>}_{i = 1}^{N}$$

for the current region, where v, represents facial feature vectors extracted by models (e.g., FaceNet) for driver IDᵢ. N denotes the number of drivers in the current region.

Encrypt Face Samples: PS encrypts the face sample library using the auxiliary server SA_{I}'s homomorphic encryption public key P̅K̅_̅{̅S̅A̅I̅}̅, obtaining homomorphic ciphertexts for cloud server

$$< {Cv}_{i} , {C}_{{ID}_{i}} {>}_{i = 1}^{N} = {Enc}_{\overline{{PK}_{SAL}}} ( \vec{{v}_{1}} , {ID}_{i} ) .$$

Transmit Encrypted Samples: PS transmits the encrypted homomorphic ciphertexts to cloud server CS_{I}, ensuring the security and privacy protection of sample data during transmission.

Store Key and Sample Information: CS_{I} stores the received information, including cloud server {CID₁, PK_{CSI}, ssk_{CSI}, C_{CSI}, PUF₂,

$$< {C}_{{v}_{i}} , {C}_{{ID}_{i}} {>}_{i = 1}^{N} \} ,$$

for subsequent processing and verification.

PS Saves Key Backup: PS also maintains a backup of the cloud server's key information, specifically cloud server {sk_{CSI}, PK_{CSI}}, for verification and data recovery purposes.

Through these steps, cloud server CS_{I} completes registration, equipped with the necessary keys and encrypted data to perform its responsibilities. This registration process ensures the security and confidentiality of data during transmission and storage, providing a foundation for secure communication within the network. The challenge-response mechanism using PUF enhances key security, and PS's periodic review and update measures further ensure the system's reliability and persistence.

RSU Registration: To ensure the effective operation of roadside units (RSUⱼ) within the system, the police station (PS) registers them. This process ensures RSUⱼ's identity verification and secure communication. The registration steps are as follows:

Select Identity and Secret Parameters: First, PS selects the identity identifier SIDⱼ and secret parameter sk_{RSj} for each RSUⱼ, calculating the corresponding public key PK_{RSj}=SK_{RSj}·P.

Transmit Identity and Secret Parameters: PS sends the message containing RSU {SIDⱼ, sk_{RSj}} through a secure channel to RSUⱼ, ensuring data integrity and confidentiality during transmission to prevent interception and tampering risks.

Select Challenge and Compute Response Values: Upon receiving the information from PS, RSUⱼ generates a random challenge value C_{RSj} and computes the response value R_{RSj}=PUFⱼ(C_{RSj}) using a physically unclonable function (PUF).

Protect Keys with PUF: RSUⱼ computes ssk_{RSj}=SK_{RSj}⊕h(R_{RSj}) using the received secret parameter and computed response value, enhancing key security with a hash function h(·).

Store Registration Information: Finally, RSUⱼ stores all pertinent information, including {SIDⱼ, PK_{RSj}, C_{RSj}, PUFⱼ, SSK_{RSj}}, for subsequent identity verification and secure communication.

Through these steps, RSUⱼ securely registers into the system, equipped with the necessary keys and authentication information to fulfill its tasks. This registration process not only ensures the security of data transmission and storage but also provides a foundation for secure communication within the network. The challenge-response mechanism using PUF effectively prevents various attacks, ensuring key confidentiality in diverse scenarios. This method allows PS to maintain a highly secure operating environment, enabling RSUⱼ to reliably execute its designated tasks within the network.

Vehicle Registration: To ensure the legitimate identity and secure operation of vehicle Vᵢ within the system, the police station (PS) registers it. This process ensures the verification of vehicle identity and secure communication. The specific steps are as follows:

Send Unique Chassis Number: Vehicle Vᵢ first sends its unique chassis number IDᵢ to the police station (PS).

Generate Registration Parameters: Upon receiving chassis number IDᵢ , PS selects a random number aᵢ and calculates Aᵢ=aᵢ·P. Then, PS calculates bᵢ=aᵢ+skₛ·h(Aᵢ∥IDᵢ|PKₛ) and returns {bⱼ, Aᵢ} to vehicle Vᵢ.

Verify Registration Information: Upon receiving {bⱼ, Aᵢ}, vehicle Vᵢ verifies. The vehicle computes bᵢP=Aᵢ+h(Aᵢ∥IDᵢ∥PKₛ) PKₛ. If the calculation results are consistent, the verification passes; otherwise, the vehicle requests PS to resend registration information.

Protect Keys with PUF: After successful verification, vehicle Vᵢ selects a challenge value Cᵥᵢ and computes response value Rᵥᵢ=PUFVᵢ(Cᵥᵢ). Then, the vehicle calculates bbᵢ=bᵢ⊕h(Rᵥᵢ).

Extract Driver Facial Features and Establish Whitelist: The driver uses models deployed on the vehicle unit to extract facial feature vectors for potential drivers such as family members. Each feature vector pairs with the corresponding identity information, forming

$$< \vec{{v}_{1}} , {ID}_{i} {>}_{i = 1}^{L} ,$$

where L denotes the number of legitimate drivers for the vehicle (typically less than 10). This data is stored in the vehicle's secure storage.

Store Registration Information: Finally, vehicle Vᵢ stores essential registration information, including vehicle {PUFVᵢ, Cᵥᵢ, bbᵢ, Aᵢ,

$${〈 \vec{{v}_{l}} , {ID}_{i} 〉}_{i = 1}^{L} \} .$$

This information is used for subsequent identity verification and secure communication.

Through these steps, vehicle Vᵢ completes registration, equipped with the necessary keys and authentication information to perform its tasks. This registration process ensures the security of data transmission and storage, providing a foundation for secure vehicle operation within the network. Meanwhile, the facial features of the driver and relatives are stored in the whitelist, ensuring that only authorized drivers can start and drive the vehicle. This process provides reliable security for vehicle operations within the network.

### Step 3: Driver Identification Phase

Once the vehicle enters normal driving mode, the onboard facial recognition system is activated to identify the driver. This phase involves scanning the driver's face using the onboard camera and extracting facial feature vectors using a neural network. The onboard camera regularly scans the driver's face, capturing facial images, which are then processed by a neural network to extract facial feature vectors \vec{xᵢ}. These feature vectors encode various dimensions of facial features.

Calculating Euclidean distance to Whitelist Each extracted facial feature vector \vec{xᵢ} is compared against stored facial feature vectors of legitimate drivers in the whitelist. For each person in the whitelist, compute the Euclidean distance:

$${d}_{j} = {\sum }_{k = 1}^{n} {( {x}_{i k} - {v}_{j k} )}^{2} ( j = 1 , 2 … L )$$

where n is the dimensionality of the feature vector, and L is the number of legitimate drivers in the whitelist. If there exists a dⱼ<σ, where σ is a predefined threshold, the current driver is recognized as legitimate, and authentication is successful, halting further actions. Otherwise, authentication fails, and the system proceeds to the next step.

The key to this phase lies in the extraction of facial feature vectors and their comparison with those stored in the whitelist. Using a neural network for facial feature extraction is an efficient and accurate method. The network converts facial images into vectors, with each element representing the strength of a feature or a specific facial characteristic. This vector representation captures crucial facial features, facilitating subsequent comparisons and identifications.

The Euclidean distance serves as a common metric for assessing similarity between two vectors. In this context, each extracted feature vector \vec{xᵢ} is compared against every legitimate driver's feature vector \vec{vⱼ} stored in the whitelist. The distance quantifies the dissimilarity between the vectors, where smaller distances indicate greater similarity.

By setting a threshold σ, the system determines whether the distance between the current driver's feature vector and any legitimate driver's vector falls within an acceptable range. If so, the driver is authenticated as legitimate, ensuring operational continuity. Otherwise, the system rejects authentication, prompting further security measures or driver checks.

The effectiveness of this phase relies on robust facial recognition technology and precise distance metrics, ensuring accurate identification of legitimate drivers. The calculation of Euclidean distances and the setting of thresholds directly influence the accuracy of identification and the overall security of the system. Therefore, thorough testing and adjustments are necessary in practical applications to ensure reliable and accurate identification.

### Step 4: Vehicle and RSU Authentication and Message Transmission

When the driver's face fails to pass the whitelist check, vehicle Vᵢ initiates mutual authentication and message transmission with roadside unit (RSU) cloud server RSUⱼ.

Here are the Detailed Steps of this Process:

Vehicle Vᵢfirst selects two random numbers a₁ and a₂. It then computes

$${R}_{vi} = P U F {V}_{i} ( {C}_{v i} ) ,$$

$${b}_{i} = b {b}_{i} ⊕ h ( {R}_{vi} ) ,$$

$${A}_{1} = {a}_{1} P ,$$

$${A}_{2} = {a}_{1} {PK}_{RSj} ,$$

$${B}_{i} = {b}_{i} + {a}_{1} h ( {A}_{1} ‖ {a}_{2} ‖ {ID}_{i} ‖ {A}_{i} ‖ {SID}_{j} ‖ {T}_{1} ) ,$$

$${BB}_{i} = {B}_{i} P ,$$

$${A}_{3} = {E}_{A 2} ( {ID}_{i} , {A}_{i} , {BB}_{i} , {SID}_{j} , {a}_{2} , {T}_{1} ) ,$$

$${A}_{4} = h ( {a}_{2} ‖ {ID}_{i} ‖ {A}_{i} ‖ {BB}_{i} ‖ {SID}_{j} ‖ {T}_{1} ) ,$$

and sends {A₁, A₃, A₄} to RSUⱼ.

RSUⱼ computes A′₂=sk_{RSj}A₁, decrypts A₃ to obtain

(IDᵢ, Aᵢ, BBᵢ, SIDⱼ, a₂, T₁)=D′_{A}_{₂} (A₃)

and checks the freshness of T₁. It then proceeds with verification. If both conditions hold:

$$B {B}_{i} = h ( {A}_{1} ‖ {a}_{2} ‖ {ID}_{i} ‖ {A}_{i} ‖ {SID}_{j} ‖ {T}_{1} ) {A}_{1} + {A}_{i} + h ( {A}_{i} ‖ {ID}_{i} ‖ {PK}_{s} ) P {K}_{s}$$

$${A}_{4}^{′} = h ( {a}_{2} ‖ {ID}_{i} ‖ {A}_{i} ‖ {B}_{i} ‖ {SID}_{j} ‖ {T}_{1} ) = {A}_{4}$$

authentication passes; otherwise, the process terminates. RSUⱼ then selects a

random number a₃ and computes:

$${A}_{5} = {a}_{3} P$$

$$S {K}_{rjvi} = h ( {a}_{2} ‖ {a}_{3} {A}_{1} ‖ {ID}_{i} ‖ {SID}_{j} ‖ {T}_{1} ‖ {T}_{2} )$$

$${A}_{6} = h ( S {K}_{rjvi} ‖ {A}_{1} ‖ {a}_{2} ‖ {A}_{5} ‖ {T}_{1} ‖ {T}_{2} )$$

Once computed, RSUⱼ sends {A₅, A₆, T₂} to Vᵢ.

Upon receiving the message, Vᵢ first checks the freshness of T₂, then computes:

$${SK}_{virj} = h ( {a}_{2} ‖ {a}_{1} {A}_{5} ‖ {ID}_{i} ‖ {SID}_{j} ‖ {T}_{1} ‖ {T}_{2} )$$

and verifies if A₆=h(SKvᵢᵣⱼ∥A₁∥a₂∥A₅|T₁ ∥T₂). If equal, authentication completes key agreement. Finally, Vᵢcomputes M₁=Eskᵥᵢᵣⱼ(<\vec{x₁}, IDᵢ>) and sends it to RSUⱼ to complete message delivery.

Message Verification and Freshness Check: The cloud server verifies received messages and checks the freshness of timestamps, ensuring message integrity and timeliness.

Key Agreement and Message Transmission: After completing verification and key agreement, the cloud server and vehicle Vᵢcan use the negotiated key for encryption and decryption, ensuring the security and confidentiality of subsequent communications. Ultimately, vehicle Vᵢsends encrypted messages to RSUⱼ to complete message delivery.

This process ensures secure communication between vehicle Vᵢ and roadside unit RSUⱼ, providing a reliable foundation for subsequent data exchange and collaboration.

### Step 5: Thief Identification Phase

When RSU receives a facial recognition request from a vehicle, to protect the privacy of facial data, RSU encrypts and transmits it to the cloud for auxiliary recognition within the area. The process is detailed as follows:

RSUⱼ first computes:

$${R}_{RSj} = {PUF}_{j} ( {C}_{RSj} )$$

$${sk}_{RSj} = {ssk}_{RSj} ⊕ h ( {R}_{RSj} )$$

$$〈 {C}_{x} , {C}_{IDx} 〉 = {E}_{\overline{{PK}_{SAl}}} ( 〈 \vec{{x}_{l}} , {ID}_{i} 〉 )$$

$${M}_{2} = \{ {E}_{{sk}_{RSj}} ( {E}_{{PK}_{CSI}} ( 〈 {C}_{x} , {X}_{IDx} 〉 , {SID}_{j} ) , {T}_{3} ) , {SID}_{j} \}$$

and sends M₂ to CS₁.

Upon receiving the message, CS₁ verifies if M₂ comes from SIDⱼ and decrypts it using its public key to obtain {E_{PK}_{_{cs1}}(<Cₓ, C_{IDx}>, SIDⱼ), T₃}. CS_{I} then checks the freshness of T₃. CS₁ decrypts {<Cₓ, C_{IDx}>, SIDⱼ} using its private key and verifies again if the message originates from RSUⱼ based on SIDⱼ. CS_{I} retrieves the homomorphic ciphertext samples of the scanned face Cₓ and the unique number of the vehicle.

Next, CS₁ computes the Euclidean distance between the scanned face and the face sample. The detailed calculation process is as follows:

$${C}_{d i} = {( {C}_{v i} - {C}_{x} )}^{2} ( i = 1 , 2 , … , N )$$

CS_{I} then randomly selects a vector \vec{rᵢ} and encrypts it using P̅K̅_̅{̅S̅A̅I̅}̅ calculating

$${C}_{r 1} = {Enc}_{\overline{P {K}_{SAl}}} ( \vec{{r}_{1}} )$$

$${Y}_{i} = {C}_{d i} - {C}_{r 1} ( i = 1 , 2 , … , N )$$

CS₁ sends Yᵢ (for i=1, 2, . . . , N) to SA₁.

Upon receiving Yi, SA₁ first decrypts it using its private key s̅k̅_̅{̅S̅A̅I̅}̅ to obtain \vec{dᵢ}-\vec{r₁}, where \vec{dᵢ}=(vᵢ₁-xᵢ₁, vᵢ₂-xᵢ₂> , . . . , vᵢₙ-xᵢₙ). SA_{I} then selects a random vector \vec{r₂} and calculates:

$${M}_{3} = \vec{{d}_{l}} - \vec{{r}_{1}} - \vec{{r}_{2}}$$

and sends it back to CS₁. CS₁ computes:

$${M}_{4} = {M}_{3} + \vec{{r}_{1}}$$

At this point, CS_{I} holds \vec{dᵢ}-\vec{r₂} and SA₁ holds \vec{r₂}. Since the subsequent Minimization operation is a non-polynomial function operation, Yao's garbled circuit is used to solve this problem. The detailed process is as follows:

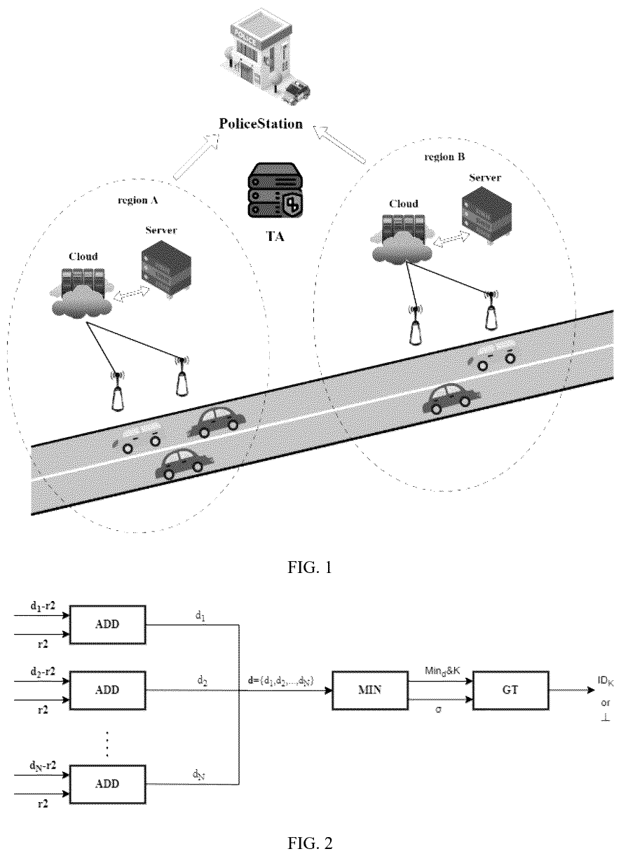

First, construct a Boolean circuit for solving the Min (t) function. The Min (t) function is designed to find the minimum value and its corresponding index in a set of values within a Boolean circuit. The input is a set of values \vec{d}={d₁, d₂, . . . , d_{N}}, and the output is the minimum value mind and its index k. The algorithm initializes mina to the first value d₁ and sets the index k to 1. It then iterates through the list starting from the second value. For each element d [i], it uses the Boolean gate GTGate to check if the current minimum mina is greater than d [i]. If true, it updates the minimum value and its index. Finally, the algorithm returns the minimum value mind and its index k. This algorithm efficiently finds the minimum value in a Boolean circuit through pairwise comparisons. Construct the complete Boolean circuit (as shown in FIG. 2). CS₁ generates a truth table based on the complete Boolean circuit and randomly permutes it. Then, CS₁ symmetrically encrypts the output of each layer and finally scrambles to obtain the final garbled circuit table (T).

CS_{I} then sends the circuit table (T) and confusion values to SA₁. CSₗ and SA₁ perform oblivious transfer (OT), where SAL obtains the confusion input values and decrypts layer by layer to obtain the final function output value (mina, K) and shares it with CS₁.

CS_{I} compares mina with threshold σ. If mind <σ, it indicates a problem during whitelist authentication of vehicle Vᵢ or a suspected thief present in the current area. CS_{I} reports the detection result to PS for decision-making. CS₁ calculates:

$${M}_{5} = \{ {E}_{s {k}_{CSl}} ( {E}_{{PK}_{s}} ( 〈 {C}_{x} , {C}_{I D x} 〉 , 〈 {C}_{{v}_{K}} , {C}_{I {D}_{K}} 〉 , {CID}_{l} ) , {T}_{4} ) , CI {D}_{l} \}$$

and sends M₅ to PS. Upon receiving M₅, PS verifies if the message comes from CID₁, decrypts it using CID₁'s public key to obtain {E_{PK}_{ₛ}(<Cₓ, C_{IDx}>, <Cᵥ_{_{K}}, C_{ID}_{_{K}}>, CID₁), T₄}, and checks the freshness of T₄. Then, PS decrypts it using its private key skₛ to obtain {<Cₓ, C_{ID}_{_{X}}>, <C_{vK}, C_{ID}_{_{K}}>, CID₁}. PS verifies the message source again based on CID₁, and since during registration phase PS has s̅k̅_̅{̅S̅A̅I̅}̅, it decrypts <Cₓ, C_{IDx}>, <Cᵥ_{ₖ}, C_{IDK}> and retrieves the scanned face and its identity <\vec{xᵢ}, IDᵢ> and thief's face and identity <\vec{V_{K}}, ID_{K}>.

If mind >σ, indicating the suspected thief is not in the current area, CS_{I} calculates:

$${M}_{6} = \{ {E}_{s {k}_{CSl}} ( {E}_{P {K}_{s}} ( 〈 {C}_{x} , {C}_{I D x} 〉 , {CID}_{l} ) , {T}_{4} ) , CI {D}_{l} \}$$

and sends M₆ to PS. Upon receiving M₆, PS verifies if the message comes from CID₁, decrypts it using CIDⱼ's public key to obtain {E_{PKs} (<Cₓ, C_{IDx}>, CID₁), T₄}, checks the freshness of T₄, decrypts it using its private key sk_s to obtain {<Cₓ, C_{IDx}>, CID₁}. Based on CID₁, PS verifies the message source again, then retrieves the plaintext scanned face and its identity <\vec{xᵢ}, IDᵢ>. Since PS maintains a national database of citizen facial templates, it calculates the thief's identity:

$$〈 \vec{{v}_{K}} , {ID}_{K} 〉 = Min ( {\sum }_{k = 1}^{A N} {( \vec{{x}_{l}} - \vec{{v}_{k}} )}^{2} )$$

In conclusion, PS tracks the stolen vehicle based on the unique chassis number IDᵢ and takes measures based on the thief's facial identity <\vec{V_{K}}, ID_{K}> to complete thief identification.

Integrated with homomorphic encryption, garbled circuits, mutual authentication, and key negotiation, the vehicle theft recognition system proposed in this embodiment exhibits high security and privacy protection capabilities. Firstly, homomorphic encryption ensures data privacy by maintaining sensitive information in encrypted form during transmission and processing. Secondly, garbled circuits enhance system complexity and defense strength, making it difficult for attackers to decipher the system through analytical processes. Finally, mutual authentication guarantees the legitimacy and authenticity of communication parties, thereby preventing various forms of attacks. Within vehicles, onboard units (OBU), roadside units (RSU), cloud servers, and auxiliary servers deploy physically unclonable functions (PUF) to resist physical device side-channel attacks, capture attacks, and collusion attacks on servers. By organically integrating these advanced technologies, this implementation addresses current challenges faced by vehicle anti-theft systems while ensuring vehicle owner privacy, providing a secure and reliable solution. This not only significantly reduces the risk of vehicle theft but also introduces new technological avenues for vehicle management and safety, offering broad application prospects and significant societal value.

The above description represents a preferred embodiment of this application, but the scope of protection of this application is not limited thereto. Any modifications or substitutions readily conceivable by those skilled in the art within the disclosed technological scope of this application should be encompassed within the scope of protection of this application as defined by the claims.

What is claimed is:

1. A method for vehicle-theft driver's identification with privacy protection, characterized by the following:
periodically acquiring the facial data of the current driver in the vehicle;
Inputting the facial data into a facial feature extraction model for feature extraction to obtain the facial feature vector of the current driver, wherein the facial feature extraction model is integrated into the vehicle's control system and is constructed based on a neural network;
Comparing the facial feature vector to be detected with the feature vectors recorded in a preset whitelist to determine if the facial feature vector to be detected is authorized. If authorized, the authentication is successful; if not authorized, the facial feature vector data is transmitted to the internet of vehicles for detection and recognition to obtain the recognition result. When the recognition result is abnormal, an alarm is generated and uploaded to the trusted authority within the vehicle network for tracking and positioning;
The internet of vehicles comprises a trusted authority and auxiliary servers, cloud servers, roadside units, and vehicles registered in the trusted authority. The trusted authority is a legitimate system for managing national citizen identity information. The auxiliary servers, cloud servers, roadside units, and vehicles all deploy physically unclonable functions.

2. A method for vehicle-theft driver's identification with privacy protection, according to claim 1, characterized by comparing the facial feature vector to be detected with the feature vectors recorded in the preset whitelist, specifically including:
Calculating the Euclidean distance value between the facial feature vector to be detected and the feature vectors recorded in the preset whitelist based on the Euclidean distance formula, and determining whether the facial feature vector to be detected is authorized based on the calculated Euclidean distance value.

3. A method for vehicle-theft driver's identification with privacy protection, according to claim 1, characterized in that the process of registering the auxiliary server with the trusted authority specifically includes:
The auxiliary server sends a registration request to the trusted authority. Upon receiving the request, the trusted authority generates a corresponding homomorphic encryption key pair and a standard encryption key pair for the auxiliary server and sends them to the auxiliary server. The auxiliary server calculates the response values of the homomorphic encryption key pair and the standard encryption key using a physically unclonable function. Based on the response values, the auxiliary server calculates the protection parameters of the keys, stores and backs up the calculated protection parameters, and completes the registration.

4. A method for vehicle-theft driver's identification with privacy protection, according to claim 1, characterized in that the process of registering the cloud server with the trusted authority specifically includes:
The cloud server sends a registration request to the trusted authority. Upon receiving the request, the trusted authority generates a corresponding standard encryption key pair for the cloud server and sends it to the cloud server. The cloud server protects and stores the standard encryption key pair using a physically unclonable function;
The cloud server selects citizen identity information according to a designated area and encrypts the selected citizen identity information using the homomorphic encryption key pair corresponding to the auxiliary server. The encrypted citizen identity information is then transmitted to the cloud server for storage and backup, completing the registration.

5. A method for vehicle-theft driver's identification with privacy protection, according to claim 1, characterized in that the process of registering the roadside unit with the trusted authority specifically includes:
The roadside unit sends a registration request to the trusted authority. Upon receiving the request, the trusted authority generates registration data for the roadside unit and sends it to the roadside unit through a secure channel, wherein the registration data includes unique identity data and a private key for the roadside unit;
The roadside unit, upon receiving the registration data, performs an availability verification. After successful verification, the roadside unit uses a physically unclonable function to protect and store the registration data and secret parameters, completing the registration.

6. A method for vehicle-theft driver's identification with privacy protection, according to claim 1, characterized in that the process of registering the vehicle with the trusted authority as follows:
Sending the vehicle's chassis number data to the trusted authority for registration to obtain registration parameters. The vehicle verifies the registration parameters, and upon successful verification, generates a key and constructs a whitelist based on citizen identity information. Storing and backing up the corresponding key and whitelist completes the registration.

7. A method for vehicle-theft driver's identification with privacy protection, according to claim 1, characterized by transmitting the facial feature vector data to the vehicle network for detection and recognition as follows:
Implementing mutual authentication and key negotiation between the vehicle and the roadside unit to obtain a session key. Encrypting the facial feature vector data with the homomorphic encryption key pair corresponding to the auxiliary server. Using the session key to encrypt the homomorphic ciphertext data of the facial feature vector, resulting in encrypted homomorphic ciphertext data. Transmitting this encrypted homomorphic ciphertext data to the cloud server, where the cloud server utilizes homomorphic encryption technology and garbled circuit techniques to perform computations and comparisons on the encrypted homomorphic ciphertext data, thereby obtaining the recognition result.
